(19) United States
(12) Patent Application Publication
(10) Pub. No.: US 2014/0347742 A1
(43) Pub. Date: Nov. 27, 2014

(54) LENS BARREL

(71) Applicant: Takahiro Ooya, Yokohama-shi (JP)

(72) Inventor: Takahiro Ooya, Yokohama-shi (JP)

(21) Appl. No.: 14/375,962

(22) PCT Filed: Mar. 22, 2013
(86) PCT No.: PCT/JP2013/059426

§ 371 Date: Jul. 31, 2014

(30) Foreign Application Priority Data
Mar. 22, 2012 (JP) 2012-065199

(51) Int. Cl. G02B 7/04; G02B 7/10; G02B 13/00

(52) U.S. Cl. CPC G02B 7/04; G02B 13/001; G02B 7/10
USPC 359/700; 359/823; 348/345

(57) ABSTRACT

A lens barrel includes: a lens holder which holds a lens group and includes a cam follower; a rotating cylinder including on a circumferential surface thereof a cam groove; a guide member to which the rotating cylinder is rotatably provided, which guides the lens holder to move in an optical axis direction; and a transmission member which transmits a drive force outputted from a drive source to the rotating cylinder. When the drive force is transmitted and the rotating cylinder rotates, the lens holder is guided in the optical axis direction and the cam groove has contact with the cam follower, and thereby the lens holder moves back and forth in accordance with a rotation posture of the rotating cylinder. The transmission member is provided on a more inner side than one, which is provided on an outermost side, of the lens holder, the guide member, and the rotating member.

### TECHNICAL FIELD

The present invention relates to a lens barrel that holds a lens group, and in particular, a lens barrel that moves the lens group in an optical axis direction.

### BACKGROUND ART

In recent years, an imaging apparatus such as a digital camera or the like has been desired to be miniaturized, and therefore, miniaturization of a lens barrel included in the imaging apparatus has been considered. A size in a radial direction of such a lens barrel increases according to an increase of the number of cylinders that is provided in order to move a plurality of lens groups held therein.

A lens barrel in which the number of cylinders is reduced has been considered such that a front lens frame that movably holds a lens group on a most photographic subject side of a plurality of lens groups is arranged outside, and a rotating cylinder that rotates so as to transmit a moving force in an optical axis direction to the front lens frame is arranged on the inside of the front lens frame (see Japanese Patent Application Publication number 2004-157380).

However, in the above-described lens barrel, a transmission member that transmits a drive force of a zoom motor in order to move each lens group to change a focal length to each holding frame that holds each lens group is provided on the outside of the front lens frame, and therefore, it is not possible to reduce the size in the radial direction, because such a lens barrel is not constituted based on a technical idea to reduce the size in the radial direction.

### SUMMARY OF THE INVENTION

An object of the present invention to provide a lens barrel that moves a lens group in an optical axis direction, and reduces a size in a radial direction.

In order to achieve the above object, an embodiment of the present invention provides a lens barrel, comprising: a lens holder which holds a lens group including at least one lens, and includes a cam follower which receives a pressing force in a direction of an optical axis of the lens group; a rotating cylinder which includes on a circumferential surface thereof a cam groove into which the cam follower is inserted, and applies the pressing force in the direction of the optical axis to the lens holder by rotating; a guide member to which the rotating cylinder is rotatably provided, which guides the lens holder in the direction of the optical axis; and a transmission member which transmits a drive force outputted from a drive source for moving the lens holder in the direction of the optical axis to the rotating cylinder; wherein when the drive force from the drive source is transmitted via the transmission member and the rotating cylinder rotates with respect to the guide member, the lens holder is guided in the direction of the optical axis by the guide member, and the cam groove is in contact with the cam follower, and thereby the lens holder moves back and forth in the direction of the optical axis in accordance with a rotation posture of the rotating cylinder, and the transmission member is provided on a more inner side than one, which is provided on an outermost side, of the lens holder, the guide member, and the rotating cylinder.

### BRIEF DESCRIPTION OF DRAWINGS

FIG. 1 is a schematic perspective diagram that illustrates an imaging apparatus 10 as an example of an imaging apparatus using a lens barrel 13 according to an embodiment the present invention, and illustrates a state of being in a predetermined storage position.

FIG. 2 is an explanatory diagram that illustrates a control block in the imaging apparatus 10.

FIG. 3 is an explanatory diagram that illustrates a schematic cross-section of the lens barrel 13, and illustrates a state of being in the predetermined storage position.

FIG. 4 is an explanatory diagram similar to FIG. 3 that illustrates a schematic cross-section of the lens barrel 13, and illustrates a state of being in a predetermined shooting standby position.

FIG. 5 is a schematic exploded perspective diagram that illustrates a straight-moving liner 47, a rotating cylinder 46, a long gear 54, a zoom geared-motor unit 55, and a base member 51 in the lens barrel 13.

FIG. 6 is a schematic perspective diagram that illustrates a state where the above-illustrated components in FIG. 5 are assembled.

FIG. 7 is an explanatory diagram that illustrates a state of the rotating cylinder 46, the long gear 54, and the zoom geared-motor unit 55 in the lens barrel 13 when viewed from a photographic subject side in the direction of a shooting optical axis OA.

FIG. 8 is a schematic explanatory cross-section diagram of the straight-moving liner 47, the rotating cylinder 46, the long gear 54, the zoom geared-motor unit 55, the base member 51, a holder 52, and a solid-state image sensor 22 in the lens barrel 13.

FIG. 9 is an explanatory diagram that illustrates a state of the lens barrel 13 when viewed from the photographic subject side in the direction of the shooting optical axis OA.

### DESCRIPTION OF EMBODIMENTS

Hereinafter, an example of a lens barrel according to an embodiment of the present invention will be explained with reference to the drawings.

### Example

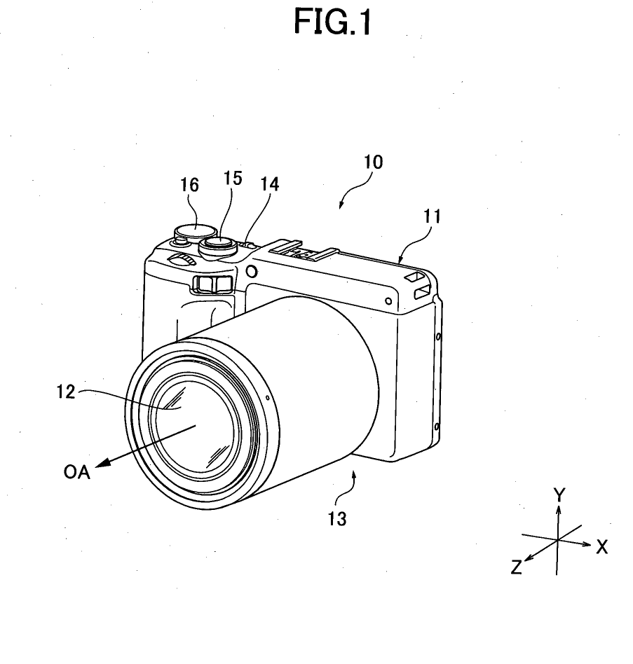

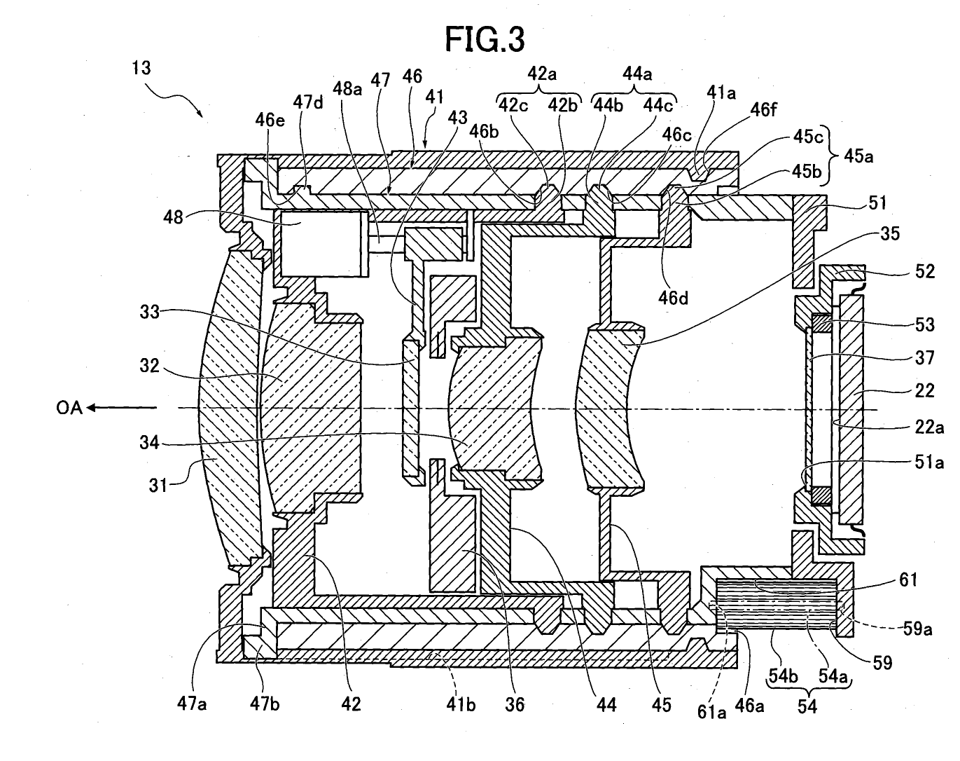

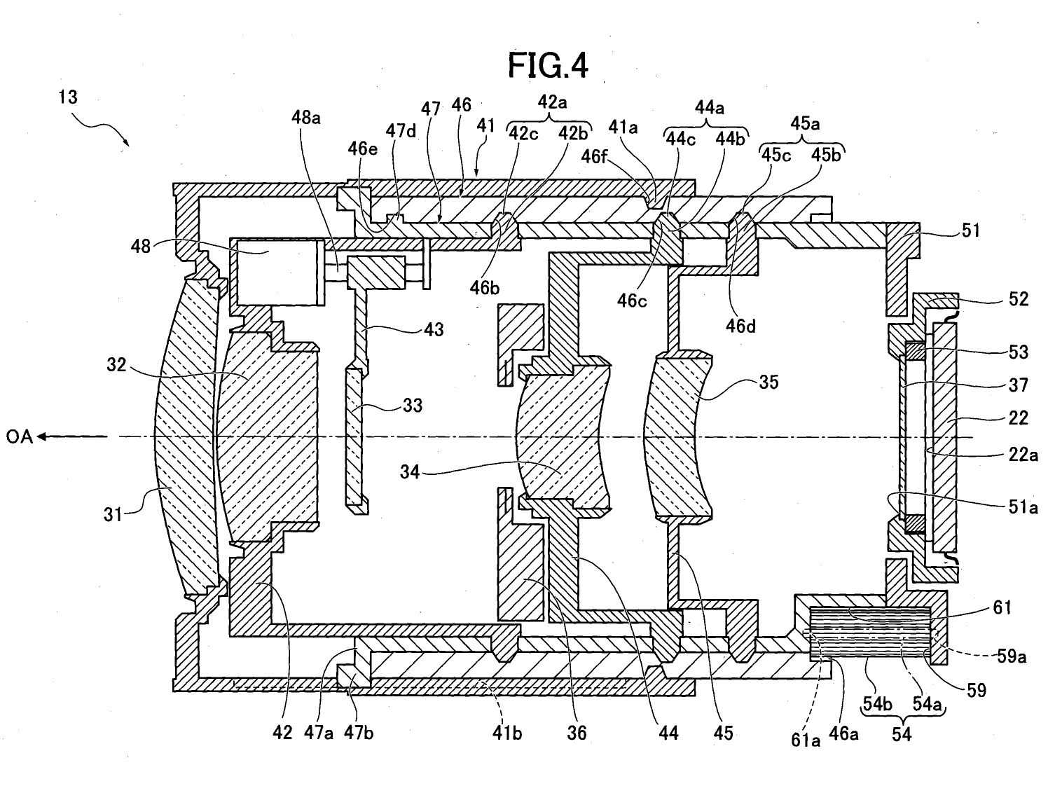

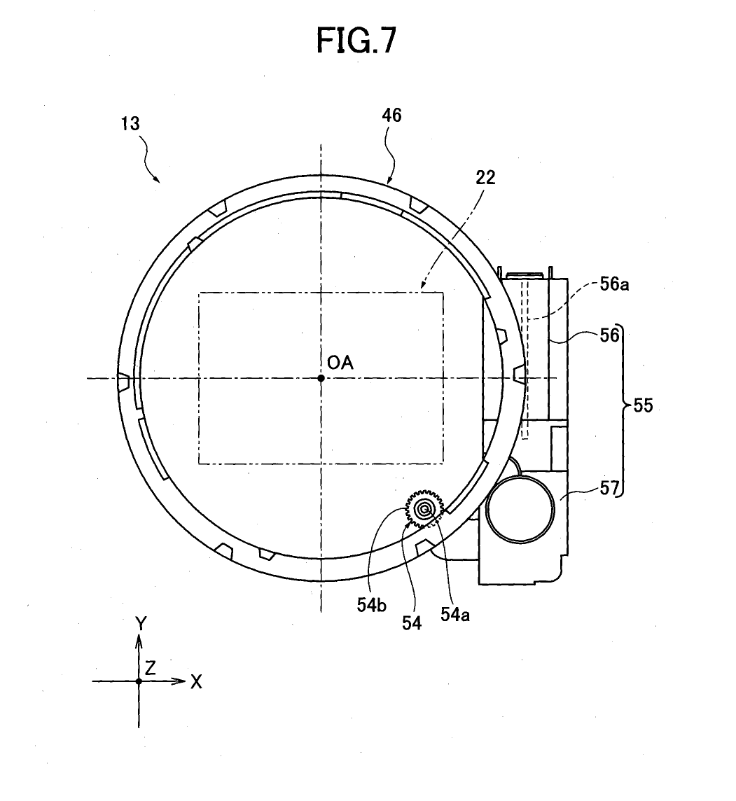

By use of FIGS. 1 to 9, schematic constitution of a lens barrel 13 as an example of a lens barrel and an imaging apparatus 10 as an example of an imaging apparatus using the lens barrel 13 according to an embodiment of the present invention will be explained. Note that in FIGS. 3 and 4, for easy understanding, the constitution of the lens barrel 13 is illustrated in a schematic cross-section. Additionally, in FIG. 7, for easy understanding, a rotating cylinder 46, a long gear 54, and a zoom geared-motor unit 55 are illustrated by a solid line, and a solid-state image sensor 22 is illustrated by a two-dot chain line.

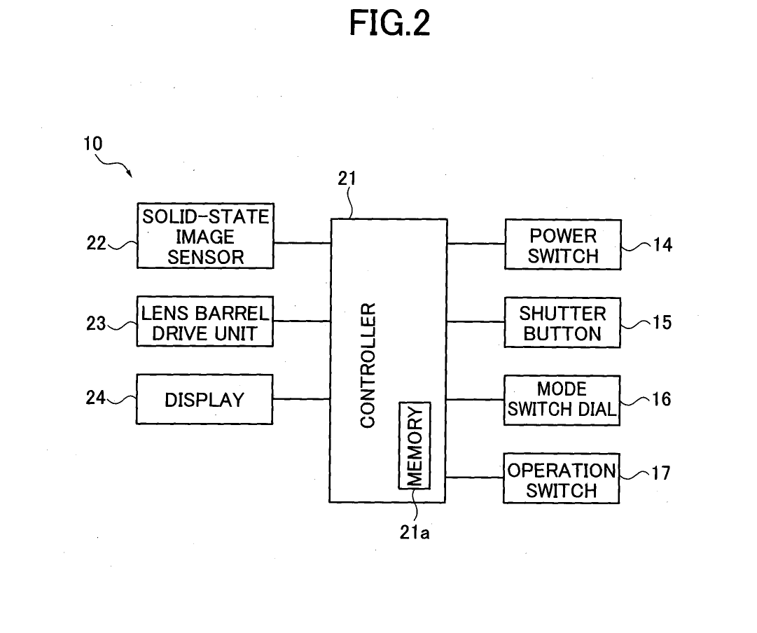

Firstly, by use of FIGS. 1 and 2, the imaging apparatus 10 as an example of an imaging apparatus (digital camera) using the lens barrel 13 will be explained. As illustrated in FIG. 1, the imaging apparatus 10 includes a camera body 11 and the lens barrel 13. The lens barrel 13 has a shooting optical system 12, and is provided on a front surface (surface on a front side of FIG. 1 in the front view) side of the camera body 11. In the illustrated example, the lens barrel 13 is constituted as a lens barrel unit detachable to the camera body 11.

In the camera body 11, on a top surface (surface on a top side of FIG. 1 in the front view), a power switch 14, a shutter button 15, and a mode switch dial 16 are provided as an operation unit. The power switch 14 operates to start up the imaging apparatus 10 (start operation), and operates to stop operating the imaging apparatus 10 (stop operation). The shutter button 15 is an operation member to be pressed when shooting a photographic subject. The mode switch 16 sets various scene modes, a still image mode, a moving image mode, and so on. Additionally, clear illustration is omitted; however, on a rear surface of the camera body 11, an operation switch 17, and a display 24 (its display screen) are provided (see FIG. 2). The operation switch 17 includes a direction indicating switch that performs various menu settings, and various switches. The display 24 displays an image based on imaged image data or image data stored in a storage medium.

In the imaging apparatus 10, by a pressing operation of the shutter button 15, image data of an image of a photographic subject received by a light-receiving surface 22a (see FIG. 3, etc.) of the solid-state image sensor 22 through a shooting optical system 12 is stored. The shooting optical system 12 includes five lens groups as described later (see FIGS. 3 and 4). The lens barrel 13 is movable between a predetermined storage position (see FIGS. 1 and 3) and a predetermined shooting standby position (see FIG. 4) along an optical axis (shooting optical axis OA) of the shooting optical system 12. FIGS. 1 and 3 illustrate the lens barrel 13 (imaging apparatus 10) in a storage position when the power is off (power switch 14 is in a off-state), and when the shooting optical system 12 (straight-moving cylinder 41 (movable lens cylinder) later described) is retracted on a most image plane side. FIG. 4 illustrates the lens barrel 13 in a shooting standby position when the power is on (power switch 14 is on an on-state), and when the shooting optical system 12 (straight-moving cylinder 41 (movable lens cylinder) later described) is extended on a photographic subject side in the direction of the shooting optical axis OA. Note that in this storage position, a shooting standby state can be set.

Hereinafter, the direction of the shooting optical axis OA of the shooting image optical system 12 outside the camera body 11 is taken as a Z-axis direction, a vertical direction in a normal usage state of the imaging apparatus 10 is taken as a Y-axis direction, and a direction perpendicular to the above two directions is taken as an X-axis direction. Here, a positive side in the Z-axis direction is taken as a front surface side (front side (photographic subject side)) of the imaging apparatus 10 (camera body 11), and a negative side in the Z-axis direction is taken as a rear surface side (rear side) of the imaging apparatus 10 (camera body 11). A positive side in the Y-axis direction is taken as an upside, and a negative side in the Y-axis direction is taken as a downside. A positive side in the X-axis direction is a left side of the imaging apparatus 10 (camera body 11) when viewed from the rear surface side, and a negative side in the X-axis direction is taken as a right side of the imaging apparatus 10 (camera body 11) when viewed from the rear surface side.

As illustrated in FIG. 2, the imaging apparatus 10 has a controller 21, the solid-state image sensor 22, a lens barrel drive unit 23, and the display 24. The controller 21 performs control of a drive operation based on operations performed by the power switch 14, the shutter button 15, and the mode switch dial 16 as the operation unit, and the operation switch 17, an image data-generating operation based on a signal from the solid-state image sensor 22, drive of the lens barrel drive unit 23 and the display 24, and the like by a program stored in a memory 21a in an integrated manner. An image obtained by the solid-state image sensor 22 via the shooting optical system 12 is appropriately displayed on the display 24 provided on the rear surface side of the camera body 11 by the controller 21.

The solid-state image sensor 22 is constituted by a CCD (Charge-Coupled Device) image sensor, a CMOS (Complementary Metal-Oxide Semiconductor) image sensor, or the like. The solid-state image sensor 22 converts an image of a photographic subject imaged on the light-receiving surface 22a (see FIG. 3, etc.) through the shooting optical system 12 to an electric signal (image data) and outputs it. The outputted electric signal (image data) is transmitted to the controller 21.

The lens barrel drive unit 23 moves each lens-holding member that holds each optical member of the shooting optical system 12 by rotating the rotating cylinder 46 with respect to the straight-moving cylinder 47, so as to move the lens barrel 13 between the storage position (see FIGS. 1 and 3) and the shooting standby position (see FIG. 4), as described later. The lens barrel drive unit 23 performs focusing by driving a focus motor 48 as described later.

Next, a schematic constitution of the lens barrel 13 as an example of a lens barrel according to an embodiment of the present invention used in the imaging apparatus 10 will be explained by use of FIGS. 3 to 9.

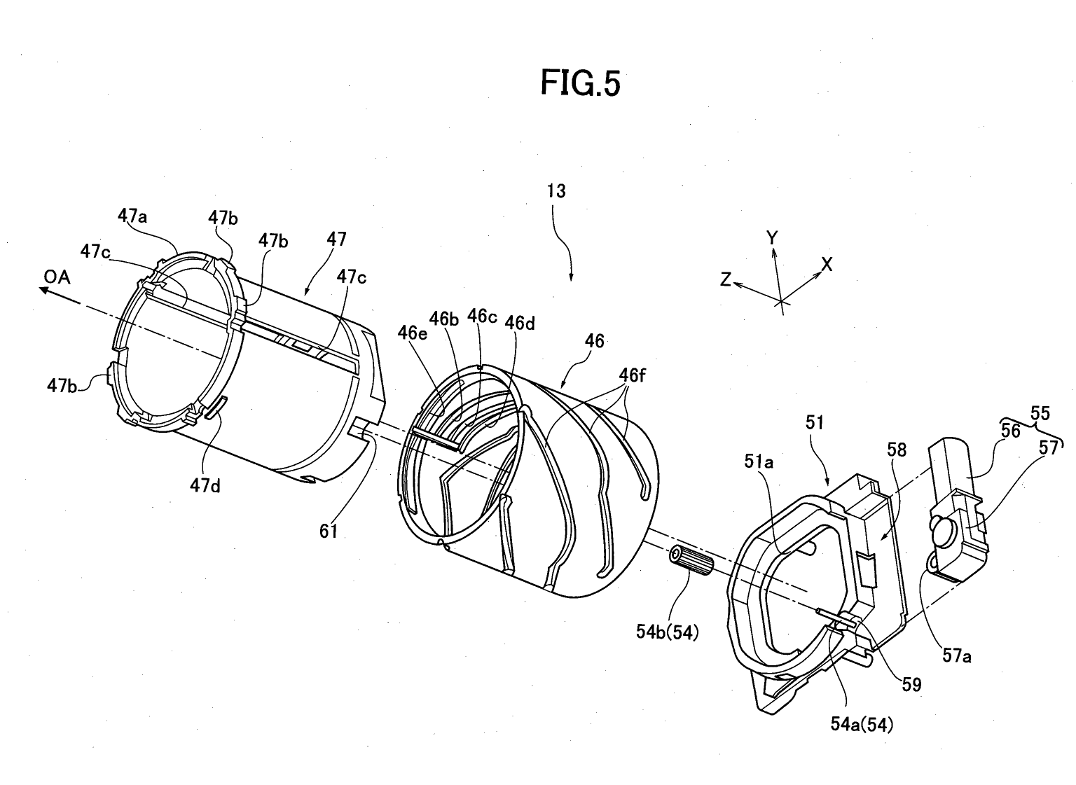

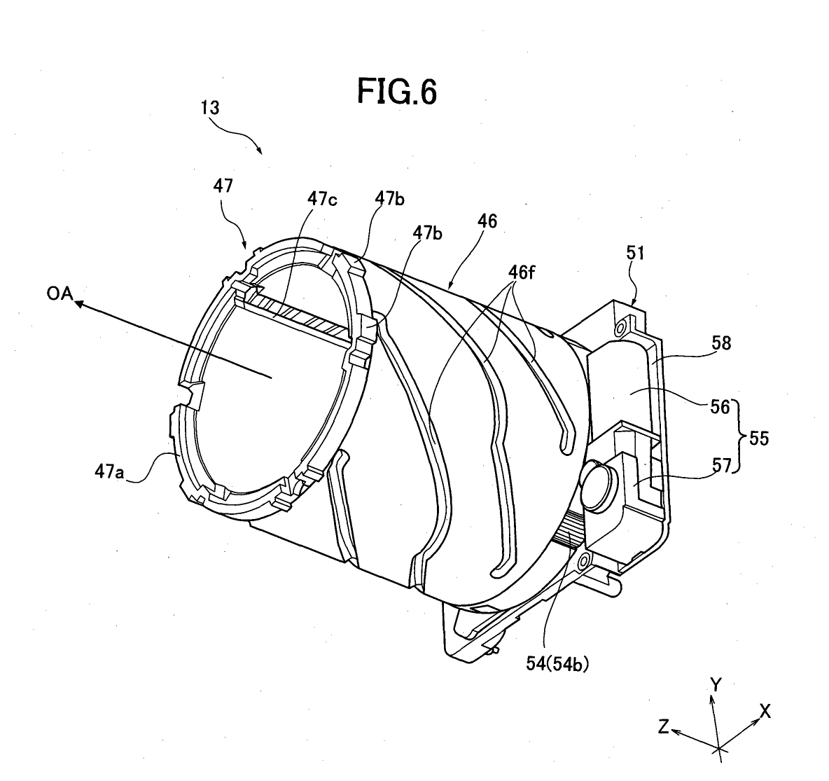

As illustrated in FIGS. 3 and 4, the lens barrel 13 includes a first lens group 31, a second lens group 32, a third lens group 33, a fourth lens group 34, a fifth lens group 35, a shutter/aperture unit 36, the solid-state image sensor 22, an optical element 37, the straight-moving cylinder 41, a second lens-holding frame 42, a third lens-holding frame 43, a fourth lens-holding frame 44, a fifth lens-holding frame 45, the rotating cylinder 46, the straight-moving liner 47, the focus motor 48, a base member 51, a holder 52, a seal member 53, the long gear 54, the zoom geared-motor unit 55 (see FIGS. 5 and 6).

In the lens barrel 13, in order from a photographic subject (object) side, the first lens group 31, the second lens group 32, the third lens group 33, the fourth lens group 34, and the fifth lens group 35 are arranged, and the shutter/aperture unit 36 is inserted between the third lens group 33 and the fourth lens group 34. On the image plane side of the fifth lens group 35, the optical element 37 and the solid-state image sensor 22 are arranged. The optical element 37 is constituted by a low-pass filter, or the like, and is provided so as to cover the light-receiving surface 22a of the solid-state image sensor 22. The optical element 37 and the solid-state image sensor 22 are held by the holder 52. The seal member 53 is provided between the holder 52 and the optical element 37, a gap between the optical element 37 and the solid-state image sensor 22 is sealed by the seal member 53. The solid-state image sensor 22 is mounted on a substrate (not illustrated) constituting an electronic circuit portion where electronic components are mounted, and the substrate is fixed to the holder 52. Clear illustration is omitted; however, the holder 52 is held by the base member 51.

As illustrated in FIGS. 5 and 6, the base member 51 is entirely in a flat-plate shape, and is in a rectangular shape when viewed in the Z-axis direction. In the center including the shooting optical axis OA of the base member 51, a mounting opening 51a that penetrates in the direction of the shooting optical axis OA (Z-axis direction) is provided. As illustrated in FIGS. 3 and 4, the optical element 37 is provided in the mounting opening 51a of the base member 51, and on a rear side of the optical element 37 (negative side in the Z-axis direction), the solid-state image sensor 22 is provided.

The first lens group 31 includes equal to or more than one lens. The first lens group 31 is fixed to the straight-moving cylinder 41 and held via a first lens-holding frame (not clearly illustrated) in which the first lens group is integrally held. The first lens group 31 has an objective lens that is arranged on a most photographic subject (object) side in the shooting optical system 12.

The second lens group 32 includes equal to or more than one lens. The second lens group 32 is fixed to the second lens-holding frame 42 and held. Therefore, the second lens-holding frame 42 functions as a lens holder that holds the second lens group 32. At a rear end on an outer circumferential surface of the second lens-holding frame 42 (end on the negative side in the Z-axis direction), a cam follower 42a is provided. The cam follower 42a protrudes radially from the shooting optical axis OA (hereinafter, also referred to as in a radial direction) from the outer circumferential surface. The cam follower 42a includes a base 42b and a protrusion end 42c. The base 42b is a portion protruding from the outer circumferential surface, and is in a circular cylindrical shape, which allows the base 42b to penetrate a straight-moving key groove 47c (see FIG. 5, etc), which is described later, of the straight-moving liner 47. The protrusion end 42c is an end portion on the outside in the radial direction of the cam follower 42a, and is in a truncated cone shape that has a smaller size in diameter than that of the base 42b, which allows the protrusion end 42c to be inserted into a cam groove 46b, which is described later, of the rotating cylinder 46. The focus motor 48 is fixed to the second lens-holding frame 42, and a lead screw 48a of the focus motor 48 is provided to be rotatable.

The third lens group 33 includes equal to or more than one lens. The third lens group 33 is fixed to the third lens-holding frame 43 and held. Therefore, the third lens-holding frame 43 functions as a lens holder that holds the third lens group 33. Clear illustration is omitted; however, the third lens-holding frame 43 is supported by the lead screw 48a of the focus motor 48 that is fixed to the second lens-holding frame 42 via a nut mechanism or a rack mechanism. Additionally, the third lens-holding frame 43 is prevented from rotating with respect to the second lens-holding frame 42, and supports the lead screw 48a to be rotatable via the nut mechanism or the rack mechanism.

The focus motor 48 is drive-controlled for control of movement of the third lens-holding frame 43 (third lens group 33) and appropriately performs rotational motion, and constitutes a drive source as the lens barrel drive unit 23 (see FIG. 2). To a motor shaft (output shaft), which is not illustrated, of the focus motor 48, the lead screw 48a is firmly fixed. The lead screw 48a extends in the Z-axis direction (direction parallel to the shooting optical axis OA) to the second lens-holding frame 42, and is provided to be freely-rotatable. The lead screw 48a has a spiral thread groove on its outer circumferential surface, which is not clearly illustrated. The focus motor 48 is appropriately driven under control of the controller 21 (see FIG. 2), so that the lead screw 48a is rotated.

This makes it possible for the third lens-holding frame 43, that is, the third lens group 33 to integrally move with the second lens-holding frame 42, that is, the second lens group 32 that is held thereby in the direction of the shooting optical axis OA, and to move in the direction of the shooting optical axis OA with respect to the second lens-holding frame 42 (second lens group 32) by drive of the focus motor 48. In the present example, the third lens group 33 is used as a focus lens that performs focusing, and when focusing, a position in the direction of the shooting optical axis OA is adjusted by a drive force from the focus motor 48.

The fourth lens group 34 includes equal to or more than one lens. The fourth lens group 34 is fixed to the fourth lens-holding frame 44 and held. Therefore, the fourth lens-holding frame 44 functions as a lens holder that holds the fourth lens group 34. The fourth lens-holding frame 44 integrally holds the shutter/aperture unit 36. At a rear end on an outer circumferential surface of the fourth lens-holding frame 44 (end on the negative side in the Z-axis direction), a cam follower 44a is provided. The cam follower 44a protrudes outward in the radial direction from the outer circumferential surface. The cam follower 44a includes a base 44b and a protrusion end 44c. The base 44b is a portion protruding from the outer circumferential surface, and is in a circular cylindrical shape, which allows the base 44b to penetrate the straight-moving key groove 47c (see FIG. 5, etc) of the straight-moving liner 47. The protrusion end 44c is an end portion on the outside in the radial direction of the cam follower 44a, and is in a truncated cone shape that has a smaller size in diameter than that of the base 44b, which allows the protrusion end 44c to be inserted into a cam groove 46c, which is described later, of the rotating cylinder 46.

The fifth lens group 35 includes equal to or more than one lens. The fifth lens group 35 is fixed to the fifth lens-holding frame 45 and held. Therefore, the fifth lens-holding frame 45 functions as a lens holder that holds the fifth lens group 35. At a rear end on an outer circumferential surface of the fifth lens-holding frame 45 (end on the negative side in the Z-axis direction), a cam follower 45a is provided. The cam follower 45a protrudes outward in the radial direction from the outer circumferential surface. The cam follower 45a includes a base 45b and a protrusion end 45c. The base 45b is a portion protruding from the outer circumferential surface, and is in a circular cylindrical shape, which allows the base 45b to penetrate the straight-moving key groove 47c (see FIG. 5, etc) of the straight-moving liner 47. The protrusion end 45c is an end portion on the outside in the radial direction of the cam follower 45a, and is in a truncated cone shape that has a smaller size in diameter than that of the base 45b, which allows the protrusion end 45c to be inserted into a cam groove 46d, which is described later, of the rotating cylinder 46.

The shutter/aperture unit 36 integrally held by the fourth lens-holding frame 44 includes a shutter and an aperture. The first lens groups 31 to the fifth lens groups 35 (including the shutter/aperture unit 36) constitute the shooting optical system 12 as a zoom lens with a variable focal length. In an imaging position of the shooting optical system 12, that is, in an image plane (a more negative side than the fifth lens group 35 when viewed in the Z-axis direction) in which an image of a photographic subject is formed by the first lens group 31 to the fifth lens group 35 (including the shutter/aperture unit 36), the light-receiving surface 22a of the solid-state image sensor 22 (electronic circuit portion) is arranged. In this specification, an optical axis line in the shooting optical system 12, that is, an axis of rotational symmetry that is a central axis of the first lens group 31 to the fifth lens group 35 is taken as a lens optical axis of the shooting optical system 12, that is, the shooting optical axis OA of the lens barrel 13.

The straight-moving cylinder 41 that holds the first lens group 31 of the shooting optical system 12 via the first lens-holding frame (not clearly illustrated) is entirely in a circular pipe shape. The straight-moving cylinder 41 functions as a lens holder that holds the first lens group 31 in cooperation with the first lens-holding frame. At a rear end on an inner circumferential surface of the straight moving cylinder 41 (end on the negative side in the Z-axis direction), a cam follower 41a is provided. The cam follower 41a protrudes inward in the radial direction from the inner circumferential surface of the straight-moving cylinder 41. The cam follower 41a is in a truncated cone shape, which allows the cam follower 41a to be inserted into a cam groove 46f, which is described later, of the rotating cylinder 46. Additionally, on the inner circumferential surface of the straight-moving cylinder 41, a straight-moving groove 41b that extends in the direction of the shooting optical axis OA is provided, which allows the straight-moving groove 41b to be in contact with a key portion 47b, which is later described, of the straight-moving liner 47. The rotating cylinder 46 is fitted into the inside of the straight-moving cylinder 41, and the straight-moving liner 47 is fitted into the inside of the rotating cylinder 46.

The straight-moving liner 47 is entirely in a circular pipe shape (see FIG. 5), and is fixed to the base member 51 to surround the mounting opening 51a. As illustrated in FIGS. 5 and 6, in the straight-moving liner 47 a flange portion 47a is provided in an end (end on the positive side in the Z-axis direction). The flange portion 47a is formed such that the end of the straight-moving liner 47 protrudes outward in the radial direction around an entire circumference of the straight-moving liner 47. In the flange portion 47a, the key portion 47b is provided. The key portion 47b is formed so as to protrude in the radial direction from an outer circumferential surface of the flange portion 47a, and is inserted into the straight-moving groove 41b (see FIGS. 3 and 4) provided on an inner circumferential surface of the straight-moving cylinder 41. Therefore, the key portion 47b and the straight-moving groove 41b are brought into contact, which allows the straight-moving liner 47 to regulate rotation of the straight-moving cylinder 41 around the shooting optical axis OA, and allows the straight-moving cylinder 41 to relatively move in the direction of the shooting optical axis OA. Therefore, the straight-moving liner 47 functions as a guide member that guides the straight-moving cylinder 41 as the lens holder to move in the direction of the shooting optical axis OA.

A straight-moving key groove 47c is provided in a circumferential wall portion of the straight-moving liner 47. The straight-moving key groove 47c is formed so as to penetrate through the circumferential wall portion in the radial direction, and extend in the direction of the shooting optical axis OA. The base 42b of the cam follower 42a of the second lens-holding frame 42, the base 44b of the cam follower 44a of the fourth lens-holding frame 44, and the base 45b of the cam follower 45a of the fifth lens-holding frame 45 penetrate the straight-moving groove 47c (see FIGS. 3 and 4). The straight-moving groove 47c allows the base 42b (cam follower 42a), base 44b (cam follower 44a), and base 45b (cam follower 45a) that penetrate to move in the direction of the shooting optical axis OA, and limits movement in the direction of rotation around the shooting optical axis OA. Therefore, the straight-moving liner 47 functions as a guide member that guides the second lens-holding frame 42, the third lens-holding frame 43 held thereby, the fourth lens-holding frame 44, and the fifth lens-holding frame 45 as the lens holders to move in the direction of the shooting optical axis OA.

A follower 47d is provided at a position in the vicinity of the flange portion 47a on an outer circumferential surface of the straight-moving liner 47. The follower 47d is provided so as to protrude in the radial direction along a plane perpendicular to the shooting optical axis OA. The follower 47d is inserted into a guide groove 46e, which is described later, of the rotating cylinder 46.

The rotating cylinder 46 is entirely in a circular pipe shape. The rotating cylinder 46 is provided so as to surround the straight-moving liner 47 (see FIGS. 3 and 4), which allows the rotating cylinder 46 to relatively rotate around the shooting optical axis OA with respect to the straight-moving liner 47. As illustrated in FIGS. 3 and 4, a gear portion 46a is formed in a base end (end on the negative side in the Z-axis direction) on an inner circumferential surface of the rotating cylinder 46. Clear illustration of the gear portion 46a is omitted; however, the gear portion 46a is formed on the inner circumferential surface of the rotating cylinder 46 such that a plurality of gear teeth that extends in the direction of the shooting optical axis OA is arranged in parallel along the direction of rotation around the shooting optical axis OA.

In addition, on the inner surface of the rotating cylinder 46, the cam grooves 46b, 46c, and 46d, and the guide groove 46e are provided. The cam groove 46b is formed so as to surround the shooting optical axis OA and shift in the direction of the shooting optical axis OA (slant to the direction of the shooting optical axis OA) (see FIG. 5). The cam groove 46b is a cam groove for movement of the second lens-holding frame 42, and it is possible for the cam groove 46b to be in contact with the protrusion end 42c of the cam follower 42a. The cam groove 46c is formed so as to surround the shooting optical axis OA and shift in the direction of the shooting optical axis OA (slant to the direction of the shooting optical axis OA) (see FIG. 5). The cam groove 46c is a cam groove for movement of the fourth lens-holding frame 44, and it is possible for the cam groove 46c to be in contact with the protrusion end 44c of the cam follower 44a. The cam groove 46d is formed so as to surround the shooting optical axis OA and shift in the direction of the shooting optical axis OA (slant to the direction of the shooting optical axis OA) (see FIG. 5). The cam groove 46d is a cam groove for movement of the fifth lens-holding frame 45, and it is possible for the cam groove 46d to be in contact with the protrusion end 45c of the cam follower 45a. The guide groove 46e is provided circumferentially along a plane perpendicular to the shooting optical axis OA (see FIG. 5), and it is possible for the guide groove 46e to be in contact with the follower 47d of the straight-moving liner 47.

Additionally, on an outer circumferential surface of the rotating cylinder 46, the cam groove 46f is formed so as to surround the shooting optical axis OA and shift in the direction of the shooting optical axis OA (slant to the direction of the shooting optical axis OA) (see FIGS. 5 and 6). The cam groove 46f is for a cam groove for movement of the straight-moving cylinder 41 with respect to the rotating cylinder 46, and it is possible for the cam grove 46f to be in contact with the cam follower 41a.

In the lens barrel 13, inside the straight-moving liner 47 fixed to the base member 51, in order from the image plane side, the fifth lens-holding frame 45, the fourth lens-holding frame 44 that holds the shutter/aperture unit 36 integrally, and the second lens frame 42 that supports the third lens-holding frame 43 are fitted. In the straight-moving liner 47, the key groove 47c (see FIG. 5, etc) receives the base 45b of the cam follower 45a of the fifth lens-holding frame 45, the base 44b of the cam follower 44a of the fourth lens-holding frame 44, and the base 42b of the cam follower 42a of the second lens-holding frame 42. Therefore, the straight-moving liner 47 allows the second lens-holding frame 42, the fourth lens-holding frame 44, and the fifth lens-holding frame 45 (including the third lens group and the shutter/aperture unit 36) to regulate rotation around the shooting optical axis OA, and relatively move in the direction of the shooting optical axis OA. Therefore, the second lens-holding frame 42, the fourth lens-holding frame 44, the fifth lens-holding frame 45 function as an inside lens holder that is provided on the inside of the straight-moving liner 47 as the guide member. The second lens group 32, the fourth lens group 34, and the fifth lens group 35 function as an inside lens group held by the inside lens holder. The cam followers 42a, 44a, 45a function as a first cam follower. The cam grooves 46b, 46c, 46d function as a first cam groove.

The rotating cylinder 46 is provided so as to surround the outside of the straight-moving liner 47. The guide groove 46e of the rotating cylinder 46 receives the follower 47d of the straight-moving liner 47, and the rotating cylinder 46 receives the straight-moving liner 47 by putting the end on the photographic subject side of the rotating cylinder 46 to the flange portion 47a (its rear end surface) of the straight-moving liner 47, which allows the rotating cylinder 46 to be prevented from moving in the direction of the shooting optical axis OA (shooting optical path) with respect to the straight-moving liner 47, and to relatively rotate (perform rotational motion) around the shooting optical axis OA.

The base 42b of the cam follower 42a of the second lens-holding frame 42 penetrates the straight-moving key groove 47c of the straight-moving liner 47, and the cam groove 46b of the rotating cylinder 46 receives the protrusion end 42c of the cam follower 42a of the second lens-holding frame 42. The base 44b of the cam follower 44a of the fourth lens-holding frame 44 penetrates the straight-moving key groove 47c of the straight-moving liner 47, and the cam groove 46c of the rotating cylinder 46 receives the protrusion end 44c of the cam follower 44a of the fourth lens-holding frame 44. The base 45b of the cam follower 45a of the fifth lens-holding frame 45 penetrates the straight-moving key groove 47c of the straight-moving liner 47, and the cam groove 46d of the rotating cylinder 46 receives the protrusion end 45c of the cam follower 45a of the fifth lens-holding frame 45.

Here, when the rotating cylinder 46 rotates around the shooting optical axis OA as the central axis line with respect to the straight-moving cylinder 47, an intersection position of the straight-moving key groove 47c and the cam groove 46b, an intersection position of the straight-moving key groove 47c of the cam groove 46c, and an intersection position of the straight-moving key groove 47c and the cam groove 46d move in the direction of the shooting optical axis OA. Therefore, when the rotating cylinder 46 is rotationally-driven with respect to the straight-moving liner 47, the second lens-holding frame 42 moves straight in the direction of the shooting optical axis OA (shooting optical path) with respect to the straight-moving liner 47 and the rotating cylinder 46 (moves in the direction of the shooting optical axis OA without rotation around the shooting optical axis OA), so as to follow a cam locus of the cam groove 46b in accordance with a rotation posture of the rotating cylinder 46. Likewise, the fourth lens-holding frame 44 and the fifth lens-holding frame 45 move straight in the direction of the shooting optical axis OA (shooting optical path) with respect to the straight-moving liner 47 and the rotating cylinder 46, so as to follow a cam locus of the cam groove 46c and a cam locus of the cam groove 46d, respectively, in accordance with the rotation posture of the rotating cylinder 46.

The straight-moving cylinder 41 is provided so as to surround the outside of the rotating cylinder 46. The straight-moving groove 41b provided on an inner circumferential surface of the straight-moving cylinder 41 receives the key portion 47b of the straight-moving liner 47 provided on the inside of the rotating cylinder 46, which allows the straight-moving cylinder 47 to regulate rotation around the shooting optical axis OA, and relatively move in the direction of the shooting optical axis OA. The cam follower 41a of the straight-moving cylinder 47 is inserted into the cam groove 46f of the rotating cylinder 46. With such a constitution, when the rotating cylinder 46 is rotationally-driven with respect to the straight-moving liner 47, the straight-moving cylinder 41 moves straight in the direction of the shooting optical axis OA (shooting optical path) with respect to the straight-moving liner 47 and the rotating cylinder 46 so as to follow a cam locus of the cam groove 46f in accordance with a rotation posture of the rotating cylinder 46. Therefore, the straight-moving cylinder 41 functions as an outside lens holder that is provided on the outside of the straight-moving liner 47 as the guide member, and the first lens group 31 functions as an outside lens group held by the outside lens holder. The cam follower 41a functions as a second cam follower. The cam groove 46f functions as a second cam groove.

Thus, in the lens barrel 13, the rotating cylinder 46 is provided on the outside in the radial direction of the straight-moving liner 47, and the straight-moving cylinder 41 is provided on the outside in the radial direction of the rotating cylinder 46. In addition to the straight-moving liner 47, the rotating cylinder 46, and the straight-moving cylinder 41, the second lens-holding frame 42, the third lens-holding frame 43, the fourth lens-holding frame 44, and the fifth lens-holding frame 45 provided on the inside of the straight-moving liner 47 are included in a cylindrical portion in the lens barrel 13.

As illustrated in FIGS. 5 and 6, in order to rotationally-drive the rotating cylinder 46 with respect to the straight-moving liner 47, that is, in order to move the shooting optical system 12 (the first lens group 31 to the fifth lens group 35), the long gear 54 and the zoom geared-motor unit 55 are provided. The zoom geared-motor unit 55 has a drive motor 56 and a gear box 57.

The drive motor 56 is drive-controlled for control of movement of the shooting optical system 12 (the first lens group 31 to the fifth lens group 35) and appropriately performs rotational motion, and constitutes a drive source of the lens barrel drive unit 23 (see FIG. 2). The drive motor 56 is constituted by a DC motor (so-called direct-current motor) in the present example. The drive motor 56 is entirely in a rectangular parallelepiped shape, and an output shaft 56a (see FIG. 7) is provided parallel to its longitudinal direction. Clear illustration is omitted; however, the output shaft 56a of the drive motor 56 includes a gear that meshes with an input gear (not illustrated) provided in the gear box 57. The gear box 57 (not illustrated) is constituted by a plurality of gears that is meshed, sufficiently reduces rotational drive in the input gear, and transmits it to an output gear 57a (see FIG. 5). Therefore, when a drive force is inputted (transmitted) from the output shaft 56a of the drive motor 56, after sufficiently reducing the rotational drive, the output gear 57a of the gear box 57 outputs (transmits) it.

In order to provide the zoom geared-motor unit 55 (drive motor 56 and gear box 57), a mounting base 58 is provided in the base member 51. The mounting base 58 is provided in a portion adjacent to the mounting opening 54a in the base member 51. In the present example, the mounting base 58 is provided in a portion on the positive side in the X-axis direction of the mounting opening 51a in the base member 51 and that extends in the Y-axis direction. In the present example, this is because the solid-state image sensor 22 that is in a rectangular shape when viewed in the direction of the shooting optical axis OA is provided in a positional relationship in which two sides of the solid-state image sensor 22 are parallel to the X-axis direction and the other two sides are parallel to the Y-axis direction in the mounting opening 51a in the base member 51 (see FIG. 7). The mounting base 58 defines a flat plane parallel to an X-Y plane, and an end on the negative side in the Y-axis direction of the mounting base 58 is continuous with a base-side mounting concave portion 59, which is later described. The negative side in the Y-axis direction of the mounting base 58 constitutes a mounting portion of the drive motor 56, and the negative side in the Y-axis direction of the mounting base 58 constitutes a mounting portion of the gear box 57. In the present example, the mounting base 58 allows the drive motor 56 that is entirely in the rectangular parallelepiped shape to be arranged in a state where the longitudinal direction of the drive motor 56 is parallel to the Y-axis direction (see FIG. 6, etc). By arranging the zoom geared-motor unit 55, that is, arranging the drive motor 56 and the gear box 57 in the mounting base 58, it is possible for the output gear 57a (see FIG. 5) of the gear box 57 to face the base-side mounting concave portion 59 from an end on the negative side in the Y-axis direction (not illustrated).

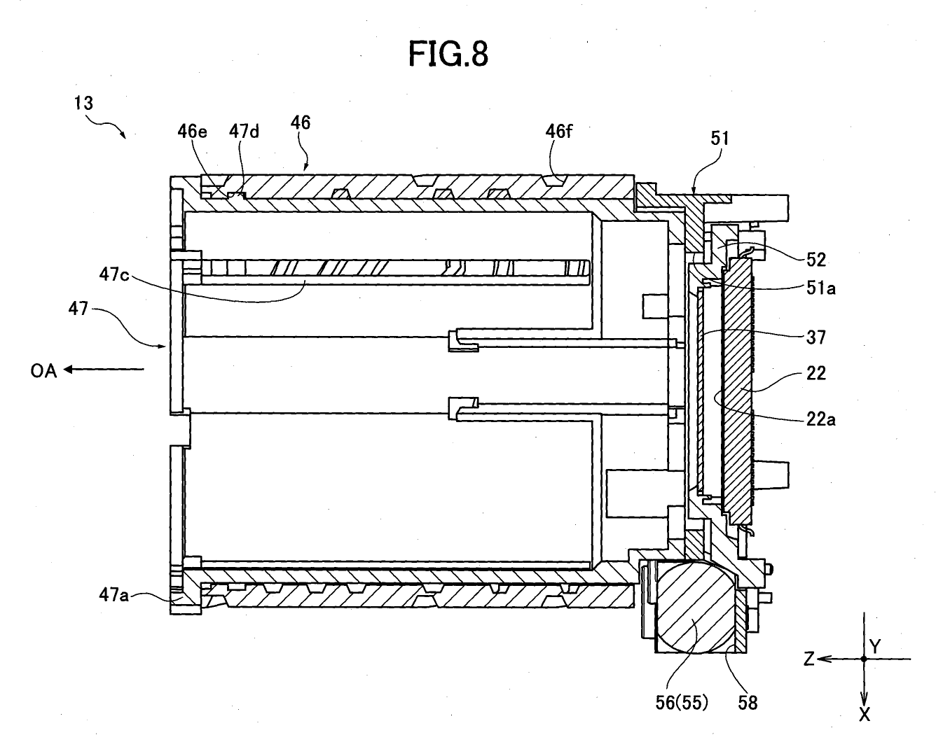

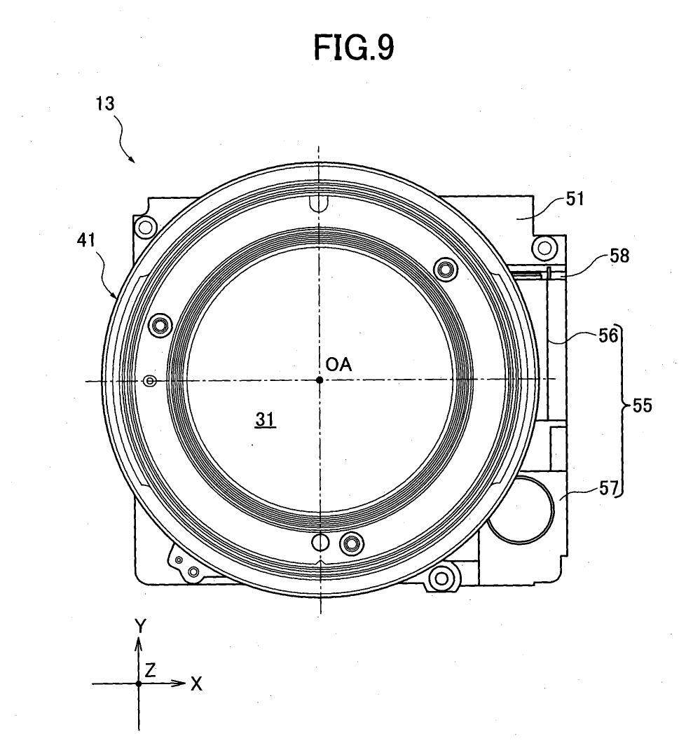

In a state where in the mounting base 58, the straight-moving liner 47, the rotating cylinder 46, and the straight-moving cylinder 41 (cylindrical portion) are assembled in the base member 51, at least a part of a mounting portion where the drive motor 56 is provided (positive side in the Y-axis direction) is located on the inside of the rotating cylinder 46 (see FIGS. 7 and 9). In the mounting base 58, the defined flat plane parallel to the X-Y plane is provided on the positive side in the Z-axis direction, that is, on the photographic subject side in the direction of the shooting optical axis OA, than a rear end surface of the solid-state image sensor 22 provided in the base member 51 via the holder 52 (surface on the negative side in the Z-axis direction) (see FIG. 8). The end on the negative side in the Y-axis direction of the mounting base 58 is continuous with the base-side mounting concave portion 59.

In the base-side mounting concave portion 59, a position on the negative side in the Y-axis direction and the positive side in the X-axis direction with respect to the mounting opening 51a on a front end surface of the base member 51 (surface on the positive side in the Z-axis direction) is formed so as to dent in a circular cylindrical shape that extends in the Z-axis direction (see FIGS. 3, 5, etc). In the base-side mounting concave portion 59, the positive side in the Z-axis direction is open, and a portion on the negative side in the Y-axis direction and the positive side in the X-axis direction is open to the mounting base 58 (see FIG. 5). The base-side mounting concave portion 59 has a size of an inner diameter which makes it possible to receive the long gear 54 to be rotatable. In the base-side mounting concave portion 59, a shaft-bearing hole 59a (see FIGS. 3 and 4) that extends in the Z-axis direction is provided on a bottom wall on the negative side in the Z-axis direction. The shaft-baring hole 59a has a size in diameter that is smaller than that of the base-side mounting concave portion 59, which receives a shaft portion 54a (one end), which is later described, of the long gear 54.

In the straight-moving liner 47, a cylinder-side mounting concave portion 61 is provided. The cylinder-side mounting concave portion 61 is formed such that a part of an outer circumferential surface dents in a cylinder shape that extends in the Z-axis direction in a base end of the straight-moving liner 47 (end on the negative side in the Z-axis direction). In the cylinder-side mounting concave portion 61, the negative side in the Z-axis direction is open, and outside in the radial direction in the straight-moving liner 47 (see FIG. 5). As illustrated in FIGS. 3 and 4, in a state where the straight-moving liner 47 is assembled in the base member 51, the cylinder-side mounting concave portion 61 and the base-side mounting concave portion 59 have a positional relationship in which the cylinder-side mounting concave portion 61 faces the base-side mounting concave portion 59 in the Z-axis direction, and the cylinder-side mounting concave portion 61 has a size of an inner diameter equal to that of the base-side mounting concave portion 59. Therefore, when the straight-moving liner 47 is assembled in the base member 51, the cylinder-side mounting concave portion 61 is adjacent to the base-side mounting concave portion 59 in the Z-axis direction, which defines a space in a single cylindrical shape that receives the long gear 54 to be rotatable. The space, that is, the cylinder-side mounting concave portion 61 (also the base-side mounting concave portion 59) is formed so as to dent the outer circumferential surface of the straight-moving liner 47 where the rotating cylinder 46 is provided outside, and therefore, when the straight-moving liner 47 and the rotating cylinder 46 are assembled as described above, the cylinder-side mounting concave portion 61 is located on the inside when viewed in the radial direction of the rotating cylinder 46. At this time, a portion that is open to the outside in the radial direction of the straight-moving liner 47 in the cylinder-side mounting concave portion 61 faces the gear portion 46a of the rotating cylinder 46 in the radial direction.

In the cylinder-side mounting concave portion 61, a shaft-bearing hole 61a that extends in the Z-axis direction is provided on an upper wall on the positive side in the Z-axis direction. The shaft-bearing hole 61a has a size in diameter smaller than that of the cylinder-side mounting concave portion 61, which makes it possible for the shaft-bearing hole 61a to receive the shaft portion 54a (the other end), which is described later, of the long gear 54. When the straight-moving liner 47 is assembled in the base member 51, the shaft-bearing hole 61a and the shaft-bearing hole 59a provided in the base-side mounting concave portion 59 of the base member 51 has a positional relationship in which they are located in a single straight line parallel to the Z-axis direction. The long gear 54 is provided in the cylinder-side mounting concave portion 61.

The long gear 54 is entirely in a long circular cylindrical shape, and a plurality of gear teeth that extends in the longitudinal direction is formed in parallel throughout an entire outer circumferential surface of the long gear 54. In the present example, the long gear 54 has the shaft portion 54a and a gear body portion 54b. The shaft portion 54a is in a long stick shape. The gear body portion 54b is in a circular pipe shape into which the shaft portion 54a is inserted, and the plurality of the gear teeth that extends in the longitudinal direction is formed in parallel throughout the entire outer circumference (see FIG. 5). In the present example, the long gear 54 is constituted such that one end of the shaft portion 54a is inserted into the shaft-bearing hole 59a of the base-side mounting concave portion 59 of the base member 51, the other end of the shaft portion 54a is inserted into the shaft-bearing hole 61a of the cylinder-side mounting concave portion 61 of straight-moving liner 47, and the gear body portion 54b is rotatably mounted with respect to the shaft portion 54a (see FIGS. 3, 5, etc). Therefore, the long gear 54 is provided such that in a circular-cylindrical shaped space formed by the cylinder-side mounting concave portion 61 of the straight-moving liner 47 and the base-side mounting concave portion 59 of the base member 51 that are continuous in the Z-axis direction, the gear body portion 54b is rotatably provided in the direction of rotation centering on an axis line of the shaft portion 54a. In other words, in the cylinder-side mounting concave portion 61, the straight-moving liner 47 rotatably holds the long gear 54 in cooperation with the base member 51 (base-side mounting concave portion 59).

In a state where the straight-moving liner 47 is thus held, in the long gear 54, in an end on the positive side in the Z-axis direction, the gear teeth provided on the gear body portion 54b are meshed with the gear portion 46b of the rotating cylinder 46. In the long gear 54, clear illustration is omitted; however, in an end on the negative side in the Z-axis direction, the gear teeth provided on the gear body portion 54b are meshed with the output gear 57a (see FIG. 5) of the gear box 57 provided in the mounting base 58 via an end on the negative side in the Y-axis direction of the mounting base 58 that is continuous with the base-side mounting concave portion 59. Therefore, it is possible for the long gear 54 to transmit a drive force outputted (transmitted) from the output gear 57a of the gear box 57 to the rotating cylinder 46 (its base end). Thus, in the present example, the long gear 54 functions as a transmission member that transmits the drive force outputted from the drive motor 56 to the rotating cylinder 46.

Next, assembly of the long gear 54 and the zoom geared-motor unit 55 in the lens barrel 13 will be explained. Note that a method and order of the assembly is not limited to the present example.

Firstly, one end of the shaft portion 54a of the long gear 54 is inserted in the shaft-bearing hole 59a provided in the base-side mounting concave portion 59 of the base member 51 and fixed (see FIG. 5). In the present example, the one end of the shaft portion 54a is pressed into the shaft-bearing hole 59a, so that the shaft portion 54a is fixed to the base-side mounting portion 59. Next, by inserting the shaft portion 54b into the gear body portion 54b, in the base-side mounting concave portion 59, the long gear 54 is provided rotatably around a rotational axis line along the Z-axis direction (in the present example, the gear body portion 54b rotates around the shaft portion 54a). Next, the rotating cylinder 46 and the straight-moving liner 47 in which the follower 47d of the straight-moving liner 47 is inserted into the guide groove 46e of the rotating cylinder 46 and assembled is assembled in the base member 51 such that the long gear 54 is received by the cylinder-side mounting concave portion 61 of the straight-moving liner 47, the other end of the shaft portion 54a is inserted into the shaft-bearing hole 61a of the cylinder-side mounting concave portion 61, and the gear teeth of the long gear 54 (gear body portion 54b) are meshed with the gear teeth of the gear portion 46a of the rotating cylinder 46. The straight-moving liner 47 is thus fixed to the base member 51. Such a fixation can be performed by adhesive-bonding, welding, or by use of a fixing member. Then, in a state (not-illustrated) where the output shaft 56a (see FIG. 7) of the drive motor 56 and the input gear of the gear box 57 are meshed via the gear, from the outside in the radial direction of the base member 51, the drive motor 56 is mounted on the positive side in the Y-axis direction of the mounting base 58, and the bear box 57 is mounted on the negative side in the Y-axis direction of the mounting base 58 (see FIGS. 5 and 6). Clear illustration is omitted; however, at this time, in an end on the negative side in the Y-axis direction of the mounting base 58, the output gear 57a of the bear box 57 (see FIG. 5) is meshed with the gear teeth of the long gear 54 (gear body portion 54b) provided in the base-side mounting concave portion 59. Therefore, in the lens barrel 13, the long gear 54 and the zoom geared-motor unit 55 are assembled.

In the lens barrel 13, the long gear 54 is rotatably held in the cylinder-side mounting concave portion 61 of the straight-moving liner 47 (in the present example, in cooperation with the base-side mounting concave portion 59 of the base member 51). The long gear 54 is provided in the cylinder-side mounting concave portion 61, and therefore, the long gear 54 is located on the inside of the rotating cylinder 46 when viewed in the radial direction (see FIGS. 3, 7, etc). The drive motor 56 of the zoom geared-motor unit 55 that transmits a drive force to the rotating cylinder 46, that is, to the long gear 54 is provided in a mounting portion on the positive side in the Y-axis direction of the mounting base 58, and therefore, the drive motor 56 overlaps with the rotating cylinder 46, and a part of the drive motor 56 is located on the inside of the rotating cylinder 46 when viewed in the direction of the shooting optical axis OA (see FIG. 7). In other words, the drive motor 56 is provided in a position that overlaps with a projection plane of the rotating cylinder 46 on a plane perpendicular to the shooting optical axis OA (plane along the X-Y plane). In addition, the drive motor 56 and the gear box 57 are mounted in the mounting base 58, and therefore, the drive motor 56 and the gear box 57 are located on the positive side in the Z-axis direction, that is, on the more photographic subject side in the direction of the shooting optical axis OA than the rear end surface of the solid-state image sensor 22 (surface on the negative side in the Z-axis direction) (see FIG. 8). In other words, on a side of the solid-state image sensor 22, the drive motor 56 and the gear box 57 are provided in a position that overlaps with an image plane (imaging plane) formed by the shooting optical system 12 in the direction of the optical axis OA, and a position that overlaps with the solid-state image sensor 22.

In the lens barrel 13, under control of the controller 21 (see FIG. 2), the drive motor 56 is appropriately driven as a drive source of the lens barrel drive unit 23. And then, a drive force of the drive motor 56 is outputted (transmitted) to the long gear 54 meshed with the output gear 57a (see FIG. 5) via the gear box 57. Therefore, the long gear 54 is rotationally-driven in the single circular-cylindrical shaped space formed by the base-side mounting concave portion 59 of the base member 51 and the cylinder-side mounting concave portion 61 of the straight-moving liner 47, and transmits the drive force (rotational force) to the rotating cylinder 46 (its base end) via the gear portion 46a meshed with the gear teeth. Thus, the drive force of the drive motor 56 is transmitted by the gear box 57 and the long gear 54, and the rotating cylinder 46 is rotationally-driven with respect to the straight-moving liner 47. Then, as described above, the straight-moving cylinder 41, the second lens-holding frame 42, the fourth lens-holding frame 44, and the fifth lens-holding frame 45 move straight in the direction of the shooting optical axis OA with respect to the straight-moving liner 47 and the rotating cylinder 46 so as to follow the cam locus of each corresponding cam groove (46b, 46c, 46d, 460 in accordance with the rotation posture of the rotating cylinder 46 (see FIGS. 3 and 4). Therefore, in the lens barrel 13, the straight-moving cylinder 41 is extended toward the predetermined shooting standby position (see FIG. 4) from the predetermined storage position (see FIG. 3), and is moved back to the predetermined storage position from the predetermined shooting standby position. At this time, the first lens group 31 held by the straight-moving cylinder 41 via the first lens-holding frame (not illustrated), the second lens group 32 held by the second lens-holding frame 42, the third lens group 33 held by the third lens-holding frame 43 provided in the second lens-holding frame 42, the fourth lens group 34 and the shutter/aperture unit 36 held by the fourth lens-holding frame 44, and the fifth lens group 35 held by the fifth lens-holding frame 45, that is, the shooting optical system 12 is thus moved straight in the direction of the shooting optical axis OA (shooting optical path).

In the present example, when the power switch 14 is turned on from the off-state, in the lens barrel 13, under the control of the controller 21 (see FIG. 2), the straight-moving cylinder 41 is extended to the shooting standby position (see FIG. 4), and the shooting optical system 12 is moved to the photographic subject side in the direction of the shooting optical axis OA. In the present example, the shooting standby position illustrated in FIG. 4 is in a state where an extension amount of the straight-moving cylinder 41 is smallest in the shooting standby position, and is a wide-angle position in the shooting optical system 12. Therefore, clear illustration is omitted; however, it is possible for the straight-moving cylinder 41 (shooting optical system 12) to extend further to the photographic subject side from the shooting standby position illustrated in FIG. 4. In this case, the first lens group 31 held by the straight-moving cylinder 41 via the first lens-holding frame (not illustrated), the second lens group 32 and the third lens group held by the second lens-holding frame 42, the fourth lens group 34 and the shutter/aperture unit 36 held by the fourth lens-holding frame 44, and the fifth lens group 35 held by the fifth lens-holding frame 45 are moved straight, that is, the shooing optical system 12 is moved straight, in the direction of the shooting optical axis OA (shooting optical path), and thus performs a zooming operation. Additionally, by the zooming operation, in a state where a focal length of the shooting optical system 12 is set, under the control of the controller 21, the focus motor 48 as the drive source of the lens barrel drive unit 23 is appropriately driven, and therefore, a position of the third lens group 33 held by the third lens-holding frame 43 in the direction of the shooting optical axis OA is adjusted, and focusing is performed. Furthermore, when the power switch 14 is turned off from the on-state, under the control of the controller 21 (see FIG. 2), in the lens barrel 13, the straight-moving cylinder 41 is moved back to the storage position (see FIGS. 1 and 3), and the shooting optical system 12 is moved to the image plane side in the direction of the shooting optical axis OA.

This makes it possible for the straight-moving cylinder 41 and the rotating cylinder 46 to move with respect to the straight-moving liner 47 in the lens barrel 13 with the second, third, fourth, and fifth lens-holding frames 42, 43, 44, 45, and the straight-moving cylinder 41 and the rotating cylinder 46 function as a movable lens barrel that moves the optical element of the shooting optical system 12 (first lens group 31, second lens group 32, third lens group 33, fourth lens group 34, shutter/aperture unit 36, and fifth lens group 35) in the direction of the shooting optical axis OA appropriately. Additionally, together with the second lens, third, fourth, and fifth holding frames 42, 43, 44, 45, the straight-moving frame 41, the rotating cylinder 46, and the straight-moving cylinder 47 function as an optical member-storing frame that stores each optical member of the shooting optical system 12 (first lens group 31, second lens group 32, third lens group 33, fourth lens group 34, shutter/aperture unit 36, and fifth lens group 35). In addition, the lens barrel drive unit 23 functions as a storing frame driver that appropriately drives the optical member-storing frame by appropriately rotating the rotating cylinder 46 by the drive motor 56.

In the lens barrel 13 according to the embodiment of the present invention, the long gear 54 that transmits the drive force from the drive motor 56 as the drive source that drives each optical member of the shooting optical system 12 in the direction of the optical axis OA to the rotating cylinder 46 is provided on a more inner side than one that is arranged on an outermost side in the cylindrical portion (straight-moving cylinder 41 in the present example), which makes it possible to reduce the size in the radial direction. This is due to the following. In conventional constitution, the transmission member that transmits the drive force to move each optical member of the shooting optical system 12 in the direction of the shooting optical axis OA is provided on the outside of the cylinder portion in the radial direction, and therefore, the size in the radial direction increase due to existence of the transmission member. On the other hand, in the lens barrel 13 according to the embodiment of the present invention, the long gear 54 is provided on the more inner side than an outer diameter of the cylinder portion. Therefore, it is possible to prevent the size in the radial direction from increasing due to the existence of the long gear 54, and the size in the radial direction becomes the size of the outer diameter of the cylindrical portion (a size of the outer diameter of the straight-moving cylinder 41).

Additionally, in the lens barrel 13, the straight-moving liner 47 has the constitution that rotatably holds the long gear 54 in the cylinder-side mounting concave portion 61, this makes it easily possible to provide the long gear 54 on the more inner side than the outer diameter in the cylindrical portion.

Further, in the lens barrel 13, the long gear 54 is meshed with the gear portion 46a formed in the base end of the rotating cylinder 46, and the drive force is transmitted to the rotating cylinder 46, which makes it possible to provide the long gear 54 in the base end in the straight-moving liner 47, and simplify the constitution for holding the long gear 54 in the straight-moving liner 47.

In the lens barrel 13, the long gear 54 is meshed with the gear portion 46a formed in the base end of the rotating cylinder 46, and the drive force is transmitted to the rotating cylinder 46, which makes it possible to provide the long gear 54 in the rear end in the straight-moving liner 47, and easily ensure a portion where the constitution for outputting (transmitting) the drive force from the drive motor 56 as the drive source is provided.

In the lens barrel 13, it is possible to provide the long gear 54 in the base end in the straight-moving liner 47, which makes it possible to provide the drive motor 56 and the gear box 57 (zoom geared-motor unit 55) in the base member 51 to which the base end of the straight-liner 47 is fixed, and shorten a transmission pathway of the drive force from the drive motor 56 to the long gear 54. Therefore, this makes it further possible to contribute to miniaturization.

In the lens barrel 13, it is possible to provide the long gear 54 in the base end in the straight-moving liner 47, which makes it possible to realize a constitution that rotatably supports the long gear 54 in cooperation with the base member 51. Therefore, it is possible to realize a simpler constitution.

In the lens barrel 13, between the straight-moving liner 47 fixed to the base member 51 in the Z-axis direction and the base member 51, the long gear 54 is inserted, and the long gear 54 is held rotatably around an axis line parallel to the Z-axis direction, which makes it possible for a simpler constitution.

In the lens barrel 13, the shaft portion 54b is held by the shaft-bearing hole 59a of the base-side mounting concave portion 59 of the base member 51 and the shaft-bearing hole 61a of the cylinder-side mounting concave portion 61 of the straight-moving liner 47, and the gear body portion 54b of the long gear 54 is rotatable around a direction parallel to the shooting optical axis OA, which makes it possible to support the long gear 54 rotatably in cooperation with the straight-moving liner 47 and the base member 51 with a simple constitution.

In the lens barrel 13, at least a part of the drive motor 56 of the zoom geared-motor unit 55 that transmits the drive force to the rotating cylinder 46, that is, to the long gear 54 is located on the inside of the rotating cylinder 46 when viewed in the direction of the shooting optical axis OA, which makes it possible to prevent the size in the radial direction from increasing due to the existence of the drive motor 56.

In the lens barrel 13, the drive motor 56 overlaps with the rotating cylinder 46 that is arranged in the middle when viewed in the radial direction of the straight-moving cylinder 41, the rotating cylinder 46, and the straight-moving liner 47 that form the cylinder portion when viewed in the direction of the shooting optical axis OA (overlaps with a projection plane of the rotating cylinder on a plane perpendicular to the shooting optical axis OA), and therefore, it is possible to be more effective in suppressing the increase of the size in the radial direction.

In the lens barrel 13, the drive motor 56 that is entirely in the rectangular parallelepiped shape is mounted in the mounting base 58 in a state where the longitudinal direction is parallel to the Y-axis direction, and the longitudinal direction (direction of an axis line of the output axis 56a) is parallel to a direction of a tangent line of a circle defined by the rotating cylinder 46, and overlaps with the rotating cylinder 46 when viewed in the direction of the shooting optical axis OA (overlaps with the projection plane of the rotating cylinder 46 on the plane perpendicular to the shooting optical axis OA), which makes it possible to be more effective in suppressing the increase of the size in the radial direction.

In the lens barrel 13, the drive motor 56 is provided in a position that is on the image plane side (negative side in the Z-axis direction) of the rotating cylinder 46 (cylindrical portion) and overlaps with the rotating cylinder 46 when viewed in the direction of the shooting optical axis OA, and the long gear 54 that transmits the drive force outputted from the drive motor 56 to the rotating cylinder 46 is provided on the inside of the cylinder portion (inner side than the rotating cylinder 46 in the present example), which makes it possible to suppress the increase of the size in the radial direction, and move each lens group (each of the first lens group 31, the second lens group 33, the fourth lens group 34, and the fifth lens group 35) back and forth in the direction of the shooting optical axis OA by rotating the rotating cylinder 46.

In the lens barrel 13, the drive motor 56 in the rectangular parallelepiped shape is provided so as to be arranged in parallel with the solid-state image sensor 22 provided in a positional relationship where in the mounting opening 51a of the base member 51 two sides are parallel to the X-axis direction and the other two sides are parallel to the Y-axis direction in the X-axis direction and extend in the Y-axis direction, which makes it possible to be more effective in suppressing the increase of the size in the radial direction.

In the lens barrel 13, the drive motor 56 is located in a position that overlaps with the image plane (imaging position) formed by the shooting optical system 12, in the Z-axis direction, that is, in the direction of the shooting optical axis OA, which makes it possible to suppress the increase of the size in the direction of the shooting optical axis OA by the existence of the drive motor 56.

In the lens barrel 13, the flat plane parallel to the X-Y plane defined by the mounting base 58 is located on the positive side in the Z-axis direction, that is, on the photographic subject side in the direction of the shooing optical axis OA than a rear end surface of the solid-state image sensor 22 provided in the base member 51 via the holder 52, and therefore, it is possible to locate the drive motor 56 in a position that overlaps with the image plane (imaging position) formed by the shooting optical system only by mounting the drive motor 56 in the mounting base 58.

In the lens barrel, the flat plane parallel to the X-Y plane defined by the mounting base 58 is located on the positive side in the Z-axis direction, that is, on the more photographic subject side in the shooting optical axis OA than the rear end surface of the solid-state image sensor 22 provided in the base member 51 via the holder 52, and therefore, it is possible to locate the drive motor 56 on the more positive side in the Z-axis direction than the rear end surface of the solid-state image sensor 22 only by mounting the drive motor in the mounting base 58.

In the lens barrel 13, the drive motor 56 is on the positive side in the Z-axis direction, that is, on the more photographic subject side in the direction of the shooting optical axis OA than the rear end surface (surface on the negative side in the Z-axis direction) of the solid-state image sensor 22, which makes it possible to suppress the increase of the size in the direction of the shooting optical axis OA by the existence of the drive motor 56.

In the lens barrel 13, the flat plane parallel to the X-Y plane defined by the mounting base 58 is located on the positive side in the Z-axis direction, that is, on the more photographic subject side in the direction of the shooting optical axis OA than the rear end surface of the solid-state image sensor 22 provided in the base member 51 via the holder 52, which makes it possible to locate the drive motor 56 and the gear box 57 on the more positive side in the Z-axis direction than the rear end surface of the solid-state image sensor 22 only by mounting the drive motor 56 and the gear box 57 (zoom geared-motor unit 55) in the mounting base 58.

In the lens barrel 13, the drive motor 56 and the gear box 57 (zoom geared-motor unit 55) are located on the positive side in the Z-axis direction, that is, on the more photographic subject side in the shooting optical axis direction OA than the rear end surface of the solid-state image sensor 22 (surface on the negative side in the Z-axis direction), which makes it possible to suppress the increase of the size in the direction of the shooting optical axis OA by the existence of the drive motor 56.

In the lens barrel 13, the rotating cylinder 46 that transmits the drive force is provided on the outside of the straight-moving liner 47 in the radial direction, and therefore, it is possible to locate the long gear 54 on a more inner side than the rotating cylinder 46 by holding the long gear 54 rotatably by the straight-moving liner 47.

In the lens barrel 13, the long gear 54 is held rotatably in the cylinder-side mounting portion 61 formed by denting the outer circumferential surface of the straight-moving liner 47, which makes it possible to locate the long gear 54 on the inside of the rotating cylinder 46 when viewed in the radial direction by simple constitution.

In the lens barrel 13, the drive motor 56 is mounted on the positive side in the Y-axis direction of the mounting base 58, the gear box 57 is mounted on the negative side in the Y-axis direction of the mounting base 58, and the zoom geared-motor unit 55 is mounted in a position adjacent to the mounting opening 51a of the base member 55 along the Y-axis direction. And therefore, when viewed in the Z-axis direction, as illustrated in FIG. 9, the zoom geared-motor unit 55 and the cylindrical portion has a positional relationship in which most of the zoom geared-motor unit 55 overlaps with the cylindrical portion. Thus, it is possible to reduce a portion that protrudes outward in the radial direction from the cylindrical portion in the zoom geared-motor unit 55 (outer diameter of the straight-moving cylinder 41 in the present example), and suppress the increase of the size in the radial direction.

In the lens barrel 13, the rotating cylinder 46 is rotated by the drive force from the drive motor 56 of the zoom geared-motor unit 55, which makes it possible to move all optical members of the shooting optical system 12 (first lens group 31, second lens group 32, third lens group 33, fourth lens group 34, shutter/aperture unit 36, and fifth lens group 35) in the direction of the shooting optical axis OA. Additionally, the long gear 54 that transmits the drive force of the drive motor 56 to the rotating cylinder 46 is provided on the more inner side than the cylinder mounted on the outermost side (straight-moving cylinder 41) in the cylindrical portion. Therefore, it is possible to suppress the increase of the size in the radial direction.

In the lens barrel 13, the increase of the size in the radial direction is suppressed by the existence of the long gear 54 and the zoom geared-motor unit 55. By setting the size of the cylindrical portion in consideration of the transmission member in the conventional constitution in which the transmission member is provided on the outside of the cylindrical portion in the radial direction, and therefore, it is possible to increase a diameter size of each lens group (each lens) provided inside of the cylindrical portion without increasing the diameter size as a whole.

In the lens barrel 13, it is possible to prevent the increase of the size in the radial direction by the existence of the long gear 54, and suppress the increase of the size in the direction of the shooting optical axis OA by the existence of the drive motor 56, and therefore, it is possible to further contribute to miniaturization.

In the imaging apparatus 10 using the lens barrel 13, the size in the radial direction of the lens barrel 13 is reduced, and therefore, it is possible to miniaturize the imaging apparatus entirely.

In the imaging apparatus 10 using the lens barrel 13, it is possible to prevent the increase of the size in the radial direction of the lens barrel 13 by the existence of the long gear 54, and suppress the increase of the size in the direction of the shooting optical axis OA by the existence of the drive motor 56, and therefore, it is possible to miniaturize the imaging apparatus entirely.

Accordingly, in the lens barrel 13 according to the embodiment of the present invention, it is possible to move the lens groups (first lens group 31, second lens group 32, third lens group 33, fourth lens group 34, fifth lens group 35) in the direction of the shooting optical axis OA, and reduce the size in the radial direction.

In the above-described example, an example of the lens barrel according to the embodiment of the present invention has been explained. However, a lens barrel can be the following lens barrel, which is not limited to the above-described example.

The lens barrel includes a lens holder; a rotating cylinder; a guide member; and a transmission member. The lens holder holds a lens group including at least one lens, and includes a cam follower that receives a pressing force in a direction of an optical axis of the lens group. The rotating cylinder has a cam groove into which the cam follower is inserted on a circumferential surface, and applies the pressing force in the direction of the optical axis to the lens-holding member by rotating. The guide member guides the lens holder to move in the direction of the optical axis, to which the rotating cylinder is rotatably provided. The transmission member transmits a drive force outputted from a drive source to move the lens holder in the direction of the optical axis to the rotating member. When the drive force from the drive source is transmitted via the transmission member, and the rotating member rotates with respect to the guide member, the lens holder is guided in the direction of the optical axis by the guide member, and the cam groove comes into contact with the cam follower, and therefore, the lens holder moves back and forth in the direction of the optical axis in accordance with a rotation posture of the rotating cylinder. The transmission member is provided on a more inner side than one, which is provided on an outermost side, of the lens holder, the guide member, and the rotating member.

Additionally, in the above-described example, the rotating cylinder 46 is fitted on the inside of the straight-moving cylinder as the lens holder, and on the inside of the rotating cylinder 46, the straight-moving liner 47 is fitted. However, as long as the straight-moving cylinder 41 (lens holder) is moved back and forth by rotating the rotating cylinder 46 with respect to the straight-moving liner 47 (guide member), the order of arrangement when viewed in the radial direction can be reversed, which is not limited to that in the above-described example.

Furthermore, in the above-described example, the straight-moving liner 47 as the guide member holds the long gear 54 rotatably. However, the long gear 54 can be provided on a more inner side than one, which is provided on an outermost side, of the straight-moving cylinder 41 as the lens holder, the rotating cylinder 46, and the straight-moving liner 47 as the guide member, which is not limited to that in the above-described example.

In the above-described example, the long gear 54 as the transmission member is constituted by the shaft portion 54a and the gear body portion 54b. However, it only has to transmit the drive force from the drive source (drive motor 56) to the rotating cylinder 46, which is not limited to that in the above-described example.

In the above-described example, the straight-moving liner 47 is constituted to hold the long gear 54 rotatably in cooperation with the base member 51. However, for example, the straight-moving liner 47 can be constituted to singly hold the long gear 54 so as to provide a stopper (by increasing the size of the outer diameter, and so on) at one end of the shaft portion 54b and fix the other end of the shaft portion 54a which is inserted into the gear body portion 54b to the straight-moving liner 47, which is not limited to that in the above-described example.

In the above-described example, the holder 52 that holds the optical element 37 and the solid-state image sensor 22 is held by the base member 51. However, the solid-state image sensor 22 can be provided separately from the lens barrel 13, which is not limited to that in the above-described example. In a case of a lens barrel having such a constitution, a positional relationship with respect to the solid-state image sensor 22 in the drive motor 56 (mounting base 58) can be a positional relationship with respect to an image sensor provided in an imaging apparatus in a state where the lens barrel is mounted to the imaging apparatus.

In the above-described example, the lens barrel 13 is mounted to the imaging apparatus 10 as an example of an imaging apparatus (digital camera). However, the lens barrel 13 can be mounted to a portable information terminal device such as a PDA (Personal Data Assistant), a mobile phone and the like having a camera function, which is not limited to that in the above-described example. This is because such a portable information terminal device also commonly includes substantially identical function and constitution as those of the imaging apparatus 10, although the appearance is slightly different. Likewise, the lens barrel 13 according to the embodiment of the present invention can be adapted to an image input device.

In a lens barrel according to an embodiment of the present invention, it is possible to move a lens group in an optical axis direction, and reduce a size in a radial direction.

Although the present invention has been described in terms of exemplary embodiments, it is not limited thereto. It should be appreciated that variations may be made in the embodiments described by persons skilled in the art without departing from the scope of the present invention defined by the following claims.

### CROSS REFERENCE TO RELATED APPLICATIONS

The present application is based on and claims priority from Japanese Patent Application Number 2012-065199, filed Mar. 22, 2012 the disclosure of which is hereby incorporated reference herein in its entirety.

1. A lens barrel comprising:
a lens holder which holds a lens group including at least one lens, and includes a cam follower which receives a pressing force in a direction of an optical axis of the lens group;
a rotating cylinder which includes on a circumferential surface thereof a cam groove into which the cam follower is inserted, and applies the pressing force in the direction of the optical axis to the lens holder by rotating;
a guide member to which the rotating cylinder is rotatably provided, which guides the lens holder in the direction of the optical axis; and
a transmission member which transmits a drive force outputted from a drive source for moving the lens holder in the direction of the optical axis to the rotating cylinder;
wherein when the drive force from the drive source is transmitted via the transmission member and the rotating cylinder rotates with respect to the guide member, the lens holder is guided in the direction of the optical axis by the guide member, and the cam groove is in contact with the cam follower, and thereby the lens holder moves back and forth in the direction of the optical axis in accordance with a rotation posture of the rotating cylinder, and
the transmission member is provided on a more inner side than one, which is provided on an outermost side, of the lens holder, the guide member, and the rotating cylinder.

2. The lens barrel according to claim 1, wherein the guide member rotatably holds the transmission member.

3. The lens barrel according to claim 1, wherein the drive force from the transmission member is transmitted to a base end of the rotating cylinder on a side of an image plane formed by the lens group when viewed in the direction of the optical axis.

4. The lens barrel according to claim 1, wherein the drive source is provided in a position that overlaps with the rotating cylinder when viewed in the direction of the optical axis.

5. The lens barrel according to claim 4, wherein the drive source is provided in a position that overlaps with an image plane formed by the lens group in the direction of the optical axis.

6. The lens barrel according to claim 5, further comprising:
an image sensor that obtains an image of a photographic subject formed by the lens group,
wherein the drive source is provided in a position that overlaps with the image sensor in the direction of the optical axis.

7. The lens barrel according to claim 1, wherein the rotating cylinder is provided on an outside of the guide member.

8. The lens barrel according to claim 1, wherein the transmission member is rotatable around a rotational axis line parallel to the direction of the optical axis.

9. The lens barrel according to claim 8, further comprising:
a base member to which a base end of the guide member on a side of an image plane formed by the lens group when viewed in the direction of the optical axis is fixed,
wherein the transmission member is provided between the guide member and the base member.

10. The lens barrel according to claim 4, wherein the drive source has an output shaft that outputs the drive force, and is provided such that the output shaft is parallel to a plane perpendicular to the optical axis.

11. The lens barrel according to claim 10, wherein the drive source is provided such that the output shaft is parallel to a direction of a tangent line of an outer circumferential surface of the rotating cylinder.

12. The lens barrel according to claim 1, wherein the lens group is an inside lens group, the lens holder is an inside lens holder, the cam follower is a first cam follower, and the cam groove is a first cam groove,
further comprising:
an outside lens group including at least one lens; and
an outside lens holder that holds the outside lens group and includes a second cam follower,
wherein the rotating cylinder is provided on an outside of the guide member, the inside lens holder is provided on an inside of the guide member, and the outside lens holder is in a circular pipe shape so as to surround the rotating member on an outside of the rotating member, and guided to move in the direction of the optical axis by the guide member, and the rotating cylinder has on an outer circumferential surface thereof a second cam groove into which the second cam follower is inserted.

13. An imaging apparatus using the lens barrel according to claim 1.

14. A digital camera using the lens barrel according to claim 1.

15. The lens barrel according to claim 1, wherein the guide member rotatably holds the transmission member, and the drive force from the transmission member is transmitted to a base end of the rotating cylinder on a side of an image plane formed by the lens group when viewed in the direction of the optical axis.

16. The lens barrel according to claim 1, wherein the guide member rotatably holds the transmission member, and the drive source is provided in a position that overlaps with the rotating cylinder when viewed in the direction of the optical axis.

17. The lens barrel according to claim 1, wherein the drive force from the transmission member is transmitted to a base end of the rotating cylinder on a side of an image plane formed by the lens group when viewed in the direction of the optical axis, and the drive source is provided in a position that overlaps with the rotating cylinder when viewed in the direction of the optical axis.

18. The lens barrel according to claim 1, wherein the guide member rotatably holds the transmission member, the drive force from the transmission member is transmitted to a base end of the rotating cylinder on a side of an image plane formed by the lens group when viewed in the direction of the optical axis, and the drive source is provided in a position that overlaps with the rotating cylinder when viewed in the direction of the optical axis.

19. The lens barrel according to claim 1, wherein the guide member rotatably holds the transmission member, and the rotating cylinder is provided on an outside of the guide member.

20. The lens barrel according to claim 1, wherein the guide member rotatably holds the transmission member, and the transmission member is rotatable around a rotational axis line parallel to the direction of the optical axis.
